(19) United States
(12) Patent Application Publication
(10) Pub. No.: US 2025/0242453 A1
(43) Pub. Date: Jul. 31, 2025

(54) Control Unit for Performing a Task Related to a Component

(71) Applicants: Robert Bosch GmbH, Stuttgart (DE); Bosch Global Software Technologies Private Limited, Koramangala (IN)

(72) Inventors: Birupaksha Pal, Bangalore (IN); Rakshith Poojari, Koramangala (IN); Sundeep Rayangowda Patil, Basaveshwaranagar (IN); Vijay Kag, Madhya Pradesh (IN)

(21) Appl. No.: 19/037,997

(22) Filed: Jan. 27, 2025

(30) Foreign Application Priority Data
Jan. 31, 2024 (IN) 2024 4100 6642

(51) Int. Cl. B23P 19/06; G05B 19/042

(52) U.S. Cl. CPC B23P 19/06; G05B 19/0425

(57) ABSTRACT

The control unit monitors and identifies at least one incomplete function related to the component in an operating mode. The control unit corrects the at least one incomplete function manually and store the data of the at least one incomplete function. The control unit builds and trains an intelligence module with the stored data. The control unit performs the task related to the component by using the trained intelligence module in real-time environment.

This application claims priority under 35 U.S.C. § 119 to application no. IN 2024 4100 6642, filed on Jan. 31, 2024 in India, the disclosure of which is incorporated herein by reference in its entirety.

This disclosure is related to a control unit for performing a task related to a component.

### BACKGROUND

Modelling of systems is one of the core areas for any engineering and scientific research. It involves figuring out mathematical relationship between the inputs and outputs of the system. Broadly speaking there are two major ways in which one can approach modelling a physical phenomenon, first to use 1st principles to figure out the constitutive equations of the system and second using measurements data to model the relationship between the inputs and outputs to the system. Moreover, recently there has been a host of developments in combining physics/1st principles with measurement data for modelling systems. The expectation of such data enhanced modelling is to achieve faster and more accurate solutions than either pure physics or pure data-based modelling individually could achieve.

A technical paper having the title: Deep Hidden Physics Models: Deep Learning of Nonlinear Partial Differential Equations discloses the time derivative of the state is known whereas the other spatial derivatives of the state and the constitutive relations of the spatial derivatives are unknown. So, the unknown part has been considered to be dependent on spatial derivates up to a certain order. And a neural network has been used to approximate that part. So, the solution strategy consists of two neural network, one as an approximation of the state and second as an approximation of the unknown part of the governing equation.

### BRIEF DESCRIPTION OF THE DRAWINGS

FIG. 1 illustrates a control unit for performing a task related to a component according to one embodiment of the disclosure; and

FIG. 2 illustrates a flowchart of a method for performing a task related to a component of in accordance with the present disclosure.

### DETAILED DESCRIPTION

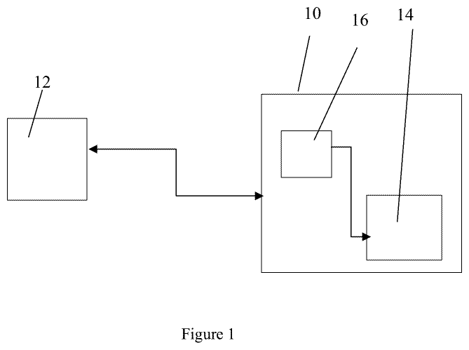

FIG. 1 illustrates a control unit for performing a task related to a component according to one embodiment of the disclosure. The control unit 10 monitors and identifies at least one incomplete function related to the component 12 in an operating mode. The control unit 10 corrects the at least one incomplete function manually and store the data of the at least one incomplete function. The control unit 10 builds and trains an intelligence module 14 with the stored data. The control unit 10 performs the task related to the component 12 by using the trained intelligence module 14 in real-time environment.

Further the construction of the control unit 10 and the components associated with the control unit 10 is explained in detail. The control unit 10 is a logic circuitry and software programs implemented as one or more microprocessors, microcomputers, microcontrollers, digital signal processors, central processing units, state machines, logic circuitries, and/or any component that operates on signals based on operational instructions. The control unit 10 comprises of the intelligence module 14 that is trained and build with the acquired/pre stored data. The control unit 10 comprises a memory 16 to store this acquired data. The working of the each component 12 involves multiple tasks and many functions to perform each task. The task comprises complete functions and incomplete functions. The at least one incomplete function is a part of the task related to the component 12.

The functions involve multiple physical parameters comprising force, distance, circumference. For example, in a manufacturing of a machine, the component 12 is a screw. And the tasks involved in the screw will be pressing, clinching, crimping in a manufacturing method. And the functions involved in the pressing the screw 12 is how much distance the screw has to go into the cavity of an outer circumference of the machine. Yet another function can be how much circumference of the screw 12 needs to be used for tightly securing the screw 12 into already available cavity on the machine.

The intelligence module is chosen from a group of intelligence modules comprising an artificial intelligence (AI) module, a deep learning (DL) module and a machine learning module (ML). These modules comprise the neural network which is build and developed as per the requirement. The component is a screw and the at least one task is a tightening task and the at least one function related to the component is a distance that the screw needs to screwed/tightened. The corrected data manually is referred as real data for training the intelligence module.

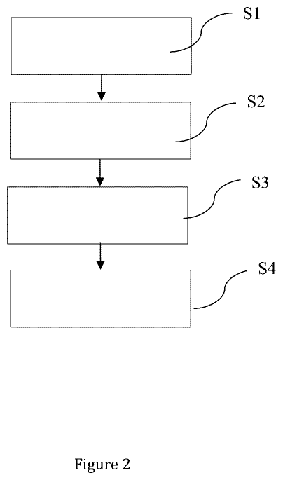

FIG. 2 illustrates a flowchart of a method for a task related to a component. In step S1, at least one incomplete function is identified related to the component 12 in an operating mode and is monitored by a control unit 10. In step S2, the at least one incomplete function is corrected manually and store the data of the at least one incomplete function. In step S3, an intelligence module 14 is built and trained with the stored data. In step S4, the task related to the component 12 is performed by using the trained intelligence module 14 in real-time environment.

The method is explained in detail. The control unit 10 identifies at least one incomplete function of a task related to the component 12. The incomplete function is monitored and is corrected using two ways. One way is, it is corrected i.e., the physical parameters required are modified manually by any of the domain expert and the corrected data is stored in the memory 16 of the control unit 10. This corrected data is referred as the real data. This data is used to build and train a neural network in the intelligence module 14. As mentioned above, there will be multiple incomplete functions present in a manufacturing process of a component is identified and is monitored, when the component 12 is in the operating mode. The second way is the incomplete function is identified and monitored when the component 12 is in operating mode. Using the pre-loaded data and with the help of the trained intelligence module 14, the task is performed by completing the function in the real time environment.

The above method is disclosed using an example. The component 12 is the screw that needs to be tightened in a machine. The amount of screw 12 that needs to be tightened and the size of the screw 12, the force in which the screw 12 to be tightened are few functions that are associated with the screw 12. If any of these functions are not complete, i.e., the physical parameters related to these functions like distance, circumference and length and the force to be applied are not calculated, then these functions are corrected/calculated using a domain expert during the calibration process.

The corrected data like the amount of force to be applied for the screw 12 to be tightened and the like is stored in the intelligence module 14 of the control unit 10, by building and training the intelligence module 14 neural network. During the real time operating scenario, the control unit 10 with the help of the intelligence module 14, corrects the incomplete functions of the tasks related to the component 12 by using the real time, which is already stored in the control unit 10. It is to be noted, the above disclosed process can be applied in any other process, on any other component that is known in the state of the art.

It should be understood that embodiments explained in the description above are only illustrative and do not limit the scope of this disclosure. Many such embodiments and other modifications and changes in the embodiment explained in the description are envisaged. The scope of the disclosure is only limited by the scope of the claims.

What is claimed is:

1. A control unit for performing a task related to a component, said control unit being configured to:
monitor and identify at least one incomplete function related to said component in an operating mode;
correct said at least one incomplete function manually and store said data of said at least one incomplete function in a memory of said control unit;
build and train an intelligence module with said stored data; and
perform said task related to said component by using said trained intelligence module in real-time environment.

2. The control unit as claimed in claim 1, wherein said at least one incomplete function is a part of said task related to said component.

3. The control unit as claimed in claim 1, wherein said intelligence module is chosen from a module comprising an artificial intelligence module, a deep learning module, and a machine learning module.

4. The control unit as claimed in claim 1, wherein said at least one incomplete function involves multiple physical parameters comprising force, circumference, and distance.

5. The control unit as claimed in claim 1, wherein said component is a screw and said at least one task is a tightening task and said at least one function related to said component is a distance that the screw needs to be tightened.

6. The control unit as claimed in claim 1, wherein said trained intelligence module recommends correction of parameters based on said data, during any one of said tasks comprising pressing, clinching, and crimping in a manufacturing process.

7. The control unit as claimed in claim 1, wherein said corrected data manually is referred as real data for training the intelligence module.

8. A method for performing a task related to a component, comprising:
monitoring and identifying at least one incomplete function related to said component in an operating mode by a control unit;
correcting said at least one incomplete function manually and storing said data of said at least one incomplete function;
building and training an intelligence module with said stored data; and
performing said task related to said component by using said trained intelligence module in real-time environment.
